(19) United States
(12) Patent Application Publication
(10) Pub. No.: US 2004/0005914 A1
(43) Pub. Date: Jan. 8, 2004

(54) Wireless communicator with integral display

(76) Inventor: Jean Paul Dear, Richmond Hill (CA)

Correspondence Address: Scott T. Wakeman, Liniak, Berenato, Longacre & White, Suite 240, 6550 Rock Spring Drive, Bethesda, MD, 20817, US

(21) Appl. No.: 10/189,761

(22) Filed: Jul. 8, 2002

(51) Int. Cl. H04B 1/38

(52) U.S. Cl. 455/563; 455/566

(57) ABSTRACT

The present invention relates to an apparatus to provide a personal communication device consisting of one or more microcircuits deposited onto a man portable substrate, said microcircuits including a voice recognition input means in order to input data, commands or messages by voice, means to configure said voice inputted data, command or message to be transmitted to another device, wireless transmitter means for transmitting said data, command or message to said other device, wireless receiver means for receiving data or messages from said other device and means to communicate data or messages received from said other device to the user. In the preferred embodiment the wireless transmitter means and wireless receiver means are embodied in a radio-frequency modem. This radio frequency modem preferably uses Bluetooth architecture.

### BACKGROUND OF THE INVENTION

1. Field of the Invention

This invention relates to a personal communication device, system software and voice entry pre-cursor. In particular the present invention provides a portable communications device and system concept, which provides convergence of devices via a wireless communications link.

2. Description of the Prior Art

As society becomes more integrated with computer technology with more and more peripherals connected to personal computers and office networks, the proliferation of cables to connect the various pieces of equipment has created new problems. Running cables from device to device and in networks, determining what cable is connected to what and un-sightly masses of tangled cables are all problems needing to be solved. Various wireless solutions have been proposed for different applications.

U.S. Pat. No. 5,797,091 is directed to a personal communication system using global positioning satellite system to provide a communication link. This patent provides a portable personal communicator system to provide geographical position data between an individual and another entity such as a communications center, a portable communications facility, another personal communicator, or the like. The communicator includes a housing sized to be personally portable by a user. A power supply connector within the housing provides electrical power to the system. A position location circuit within the housing powered by the electrical power provides position data to indicate the location of the user. A transmitter using a cell phone or pager network within the housing and powered by the electrical power transmits the position data from the personal communicator to the other entity. A plurality of command buttons coupled to the housing and responsive to user input control communication between the personal communicator and the communications center. At least one of the pluralities of buttons is designated as an emergency button with at least a second of the plurality of command buttons being designated as a non-emergency button. A sound generator within the housing powered by the electrical power generates an audible sound in the form of an alarm as opposed to voice or music in response to the sound generation command.

U.S. Pat. No. 6,223,291 provides a wireless electronic commerce system comprising a wireless gateway to a wireless network with which a wireless client having a unique client identifier is capable of communicating and at least one server coupleable to the wireless gateway, delivering content items to the wireless device and maintaining digital content certificates for content items and digital license certificates for licenses for the content items. The server maintains, for each wireless client associated with the system, a record of licenses for that client and a record of content items associated with each license. This patent is mainly concerned with e-commerce and specifically tracking wireless data for the purposes of billing the user. While it does cover wireless transfer of email and the associated wireless gateway it is mainly based on long distance wireless e-commerce over the cell-phone network. There is no discussion of the physical wireless device, how it would be powered for a reasonable period of time or how it could be miniaturized and portable.

U.S. Pat. No. 6,327,152 shows a “stacking method” for a structure wherein a hand held computer module can be conveniently and interchangeably coupled to accessory devices. The hand held computer module is detachably connected to a first accessory module by means of a first interlocking structure. The first interlocking structure includes a first interlock mechanism on the computer module and a second interlock mechanism on the first accessory module, the first and second interlock mechanisms being mated together to form a physical connection between the computer module and the first accessory module. The first accessory module also includes a third interlock mechanism which is similar to the first interlock mechanism. A second accessory module has a fourth interlock mechanism which is similar to the second interlock mechanism. Accordingly, the first accessory module can be detachably connected to a second accessory module by means of a second interlocking structure which includes the third and fourth interlock mechanisms. Alternatively, the third accessory module can be connected to the computer module using the first and fourth interlock mechanisms. Power and data are transferred between the modules by means of electrical contacts which are brought into contact when the modules are physically connected by means of the interlock mechanisms. Contact between the electrical contacts forms a bus linking the modules together electrically.

U.S. Pat. No. 6,335,688 describes a method and system for airport or building security where a passenger or other person presents him/herself at the check-in counter in the normal way. A government generated picture ID is also presented in the normal way (drivers license, passport, etc.). The present invention however then requires additional positive identification by fingerprint scan, retina scan, voice scan, handprint, palmprint, finger length comparison, or other means. In addition, a new photo can be taken of the passenger during check-in. The total data thus acquired can be compared against law enforcement, FBI, databases (also INTERPOL, etc.), or immigration to determine immediately if the potential passenger is wanted or known to be dangerous. There needs to be no indication at the check-in counter if a positive ID is made on a dangerous individual; rather, airport security personnel are immediately notified. After the ID process, the passenger can be checked into the flight in the normal way and then given a smartcard wireless device (which will be called a PASS smartcard) which serves as a boarding pass and airport tracking device. The pass smartcard is a small, flat, card like a credit card that can contain electronics and wireless communication capabilities. Since the location of this smartcard wireless device can be tracked in the airport by normal wireless antenna location means, by GPS, or by direction fixing between multiple antennas, or any other tracking means, the approximate location of the person is known at all times while in any area of the airport or building. In the case of a positive ID of a dangerous or wanted individual, law enforcement officials can apprehend the person anywhere in the airport or building that allows a safe and non-disruptive apprehension.

Some wireless solutions required line of sight between devices. Recently a new wireless cable-replacement technology known as Bluetooth™ was conceived. Bluetooth is a standard for a small, inexpensive radio chip to be inserted into computers, printers, mobile phones etc. Bluetooth is designed to replace cables by taking the information normally carried by the cable and transmitting it at a special frequency to a receiver Bluetooth chip located in the destination device i.e. computer, printer, mobile phone etc, and which relays the information to the device to be acted upon. Bluetooth allows for the formation of “ad hoc” networks whenever the Bluetooth devices come within 10 m of each other. Once the device leave the temporary “cell” the network is dissolved.

There is a need, in order to take advantage of the emerging wireless technology for a simple personal communication device that will link the user with various devices in the home and office including computer, telephone, automobile, lights, security system (etc.) and permit voice communication to direct commands to these devices. Problems that need to be addressed include battery life, display technology, thin client architecture, data input and computational and storage requirements.

### SUMMARY OF THE INVENTION

It is an object of the invention to provide in an embodiment a personal communication device that is voice controlled and preferably includes a voice command pre-cursor.

It is a further object of the invention to provide in an embodiment a personal communication device that permits convergence of various electronics/electromechanical devices, covers various communications media and provides ubiquitous application.

It is a further object of the invention to provide in an embodiment a personal communication device that utilizes software configurable radio frequency modems.

It is a further object of the invention to provide in an embodiment a personal communication device that is disposable and/or recyclable.

It is a further object of the invention to provide in an embodiment a personal communication device that utilizes a touch-screen over an organic light emitting (OLED) display.

It is a further object of the invention to provide in an embodiment a personal communications device that utilizes an ultra-low power radio frequency identification (RFID) tag to monitor radio frequency (RF) traffic and serve to conserve radio-modem receive power.

It is a further object of the invention to provide in an embodiment a personal communication device that incorporates a secure digital port on a card format.

It is a further object of the invention to provide in an embodiment a personal communication device that incorporates Vortex™ speed-reader software.

Thus in accordance with the present invention there is provided a personal communication device consisting of one or more microcircuits deposited onto a man portable substrate, said microcircuits including a voice recognition input means in order to input data, commands or messages by voice, means to configure said voice inputted data, command or message to be transmitted to another device, wireless transmitter means for transmitting said data, command or message to said other device, wireless receiver means for receiving data or messages from said other device and means to communicate data or messages received from said other device to the user. In the preferred embodiment the wireless transmitter means and wireless receiver means are embodied in a radio-frequency modem. This radio frequency modem preferably uses Bluetooth architecture.

In another embodiment the personal communication device according to present invention includes means to extend battery life selected from the group consisting of:

Use of low-power, short-distance radios (Bluetooth/802.11x) including ultra low-power RFID tag technology to monitor radio traffic;

Use of OLED display technology;

ingenious uses of battery technologies and recyling rechargeable alkaline battery (Powerburst technology), rechargeable catalyst fuel-cell technology (methane), rechargeable Lithium-Ion, Lithium-Polymer or rechargeable Ultracap technology;

smart card technology and credit-card form factor; or

Vortex™ display output.

One way the present invention solves the problem of battery life in a portable communicator is by using a low-power (Bluetooth) radio frequency (RF) transmitter and by making the device recyclable. Longer distance communication can be accomplished by a wireless (Bluetooth) link to a cell-phone in close proximity or a wired (internet) connection from a nearby personal computer (PC). This reduces the power consumption compared to the latest personal digital assistants (PDAs) and laptops that typically use higher power cell-phones as radio-modems. When the battery charge is depleted, the unit can be forwarded to a depot for recharging. This permits the device to be very inexpensive and therefore a user could have several charged devices at his disposal and activate a new one when the battery of the present device is spent. The new device would activate with a login name and password.

By using an OLED display, backlighting which is usually accomplished by the use of miniature fluorescent tubes or light emitting diodes (LEDs) is not required since OLEDs are emissive by design. Use of emissive OLED eliminates the extra power used in illuminating (backlighting) a conventional LCD display. Also, some of the communicator circuitry may be realized in the electro-polymeric structure of the OLED.

Ultra low-power RF tag technology is used to monitor radio traffic until valid information is detected. This would reduce the dependence on the Bluetooth receiver which uses several milliwatts of power to function. Radio frequency identification (RFID) tags are the latest technology in ultra low-power radios. Their intended use is as RF identification tags for retail or warehouse security. In those applications the tags are attached to all merchandise in the store or warehouse and the location of the products can be monitored wirelessly. For the purposes of the present invention the RFID tags would be used to monitor the RF environment and alert the system when valid Bluetooth data is available. At that point the higher-powered system Bluetooth radio would take data relay. This approach will further reduce the power requirements of the communicator.

By nature of a thin-client architecture the present invention uses the computational and storage power of nearby devices (PC's, laptops, PDA's within the Bluetooth range). Compared to conventional PDA's this reduces the requirement to power large amounts of storage memory. Since Bluetooth only requires a few milliwatts of transmit power the battery life would be much longer than Global System for Mobile Communication (GSM), Code Division Multiple Access (CDMA), or General Packet Radio System (GPRS-cell-phone based) devices which can require up to 2 Watt bursts.

VORTEX™ software is preferably employed to further reduce power consumption. Vortex displays only one word of an English sentence at a time to the reader. With practice the reader can reach speeds of several hundred words-per-minute. This provides a very simple email/text interface using limited display area and hence reduced power consumption.

Further features of the invention will be described or will become apparent in the course of the following detailed description.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a block diagram of some of the components of one embodiment of a personal communication device according to the present invention.

FIG. 2 is a perspective view of one embodiment of the personal communication device using the components of FIG. 1.

FIG. 3 is a cut-away plan view of the circuit layer of the personal communication device of FIG. 2.

FIG. 4 shows schematically a personal communication device of the present invention and various devices it can communicate with in accordance with the present invention.

FIG. 5 is a schematic diagram of software configurable radio-frequency modem used in a preferred embodiment of the present invention.

### DETAILED DESCRIPTION OF THE PREFERRED EMBODIMENT

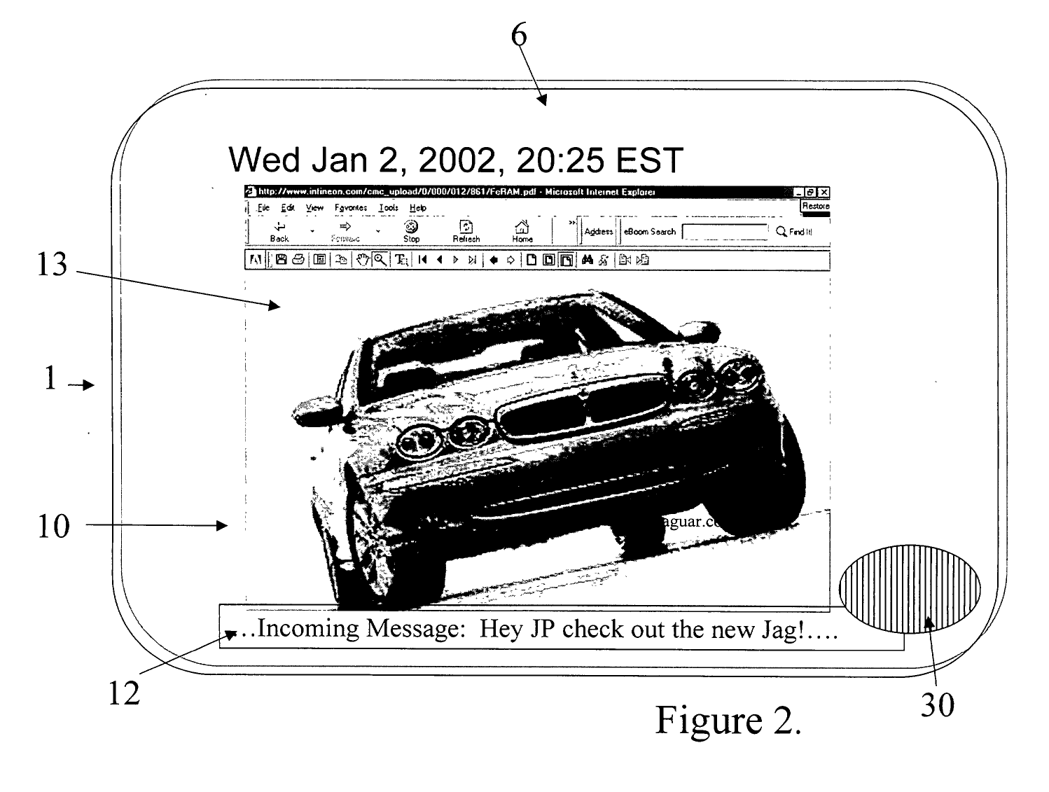

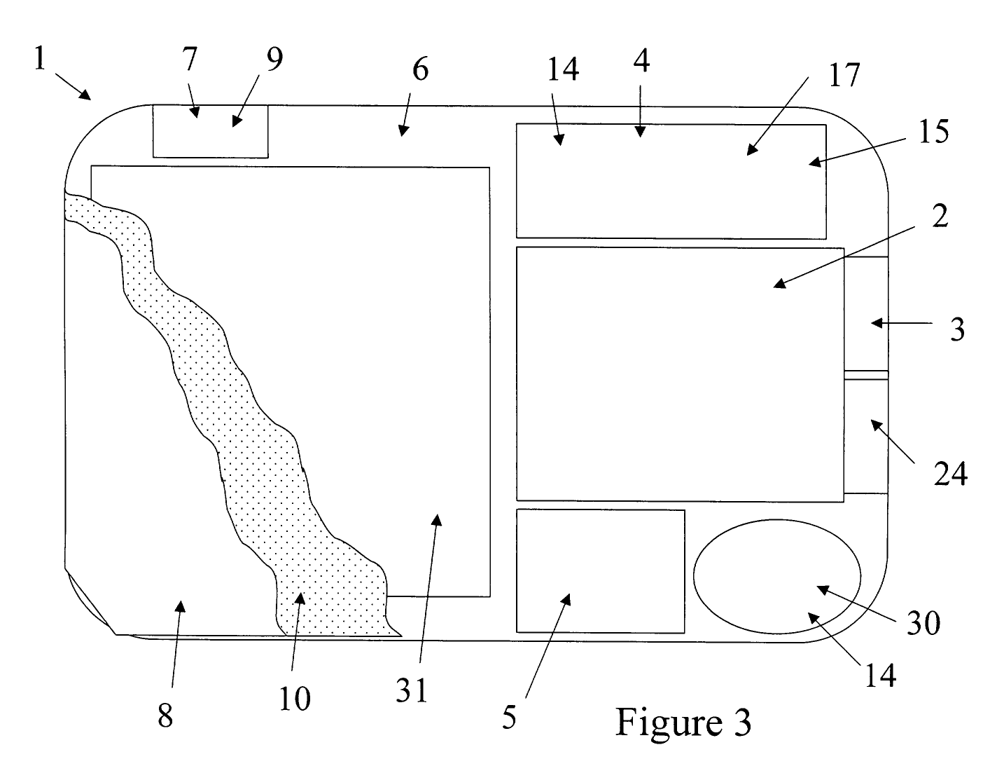

Referring to the Figures, one embodiment of a personal communication device according to the present invention is generally indicated at 1 in FIGS. 2 and 3. The personal communication device 1 consists of a single or several microcircuits 2, 3, 4, 5 deposited onto a plastic or rigid substrate 6 to provide a physical medium for the device. The substrate 6 and microcircuits 2, 3, 4, 5 are man portable and easily stored or concealed in ones clothing, on ones person or sub-cutaneously embedded. The device of the present invention may take several forms including jewelry, watch, credit card and lapel pin preferably using a thin-client concept and the computing power and storage capacity of existing and future devices. It can be realized on a substrate 6 in credit-card format (as shown in FIGS. 2-4) or wearable, pinned on shirt, necklace, shirt-pocket, belt, purse clip, wallet, shirt-pocket, or wrist strapped. The personal communication device of the present invention is an inexpensive and easily portable device allowing one to be (wirelessly) in constant communication with and in command of a host of existing and future electronic and mechanical devices. The present invention can be realized by but not restricted to silicon smartcard technology, ASIC technology and OLED technology. Electronic, fluid, photonic, electro-polymeric and neural computing and communications technologies are included.

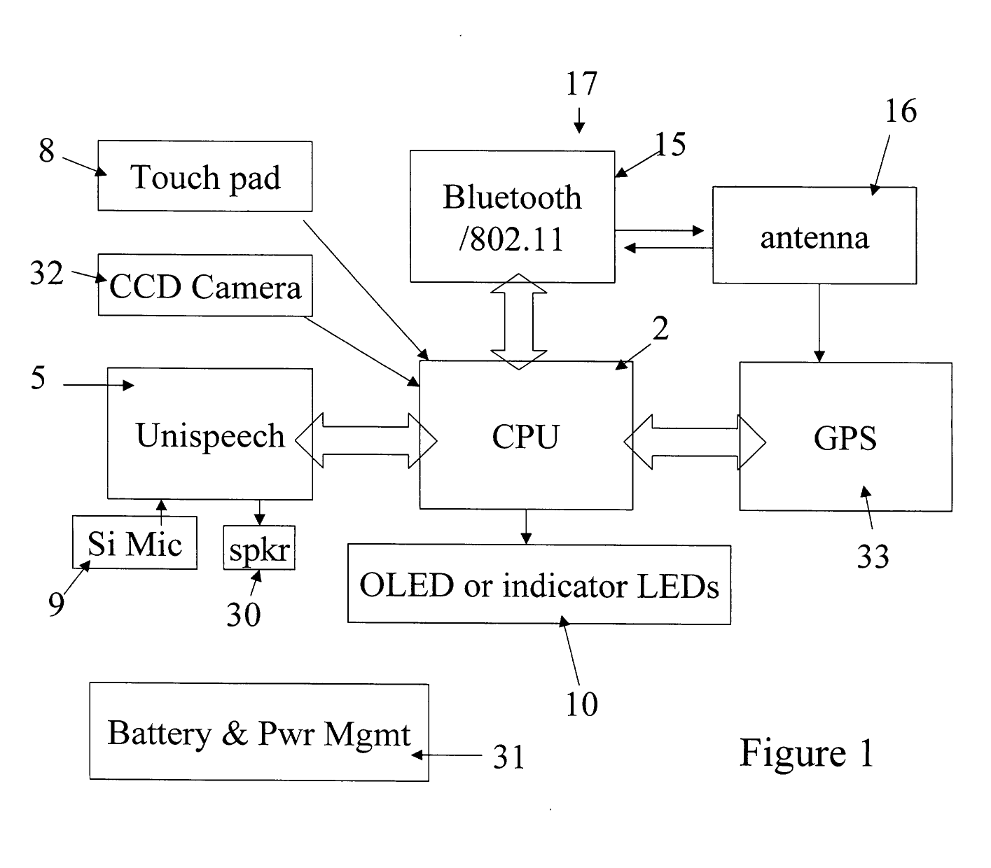

As shown in FIGS. 1 and 3, input means, generally indicated at 7, are provided on the substrate 6 and in the preferred embodiment utilize primarily voice recognition by way of microphone 9 and microcircuit 4. The present invention also may include a voice-command precursor to improve noise performance and accuracy. The “voice entry pre-cursor” is a method of improving the performance of voice activated and controlled systems. It consists of a distinct word, coded word or sound which is uttered or otherwise produced and which precedes the actual command word. Input means 7 may also include a tactile input via a touch-screen 8. The precursor will alert the device that there is a command to follow and will ignore commands not prefixed. In this way the controlled device will not respond to commands which are uttered accidentally or which turn up in natural conversation. Secondly, filtering may be employed to further reduce the possibility of erroneous commands.

Input means 7, in the preferred embodiment, is a microphone 9 connected to the microcircuit 4, which permits data entry by voice. However as a silent alternative, data may alternatively be entered by stylus or touch-screen keypad 8. The optional keypad is displayed as a virtual keyboard 8 on a display 10 preferably an OLED display. OLED's solve the problem of having to illuminate (backlight) the display as OLED's are emissive and not reflective like LCDs (liquid crystal displays). It would be very difficult to power a conventional LCD display and its associated illumination for more than a day in this application. Further, OLED's can be viewed in outdoor, indoor and dark environments and have superior visibility at all viewing angles. Monochrome and colour displays are possible.

As shown in FIG. 3, the OLED display has a transparent overlay 11 allowing for “hunt and peck” with finger or stylus or typing using thumbs only. The keyboard 8, being virtual, is software configurable as qwerty, alphabetical, kanji or otherwise.

As noted above, incoming text data display is software configurable and can utilize a limited display area 12 to save battery power. Therefore it preferably uses plain text, banners, HTML and variants. The balance 13 of the display 10 can be used to present pictures or graphics and time and date information. Vortex software displays only one word at a time. The user can adjust the rate at which words are displayed until a comfortable speed is achieved. It has been shown that comprehension and the speed of reading can be greatly enhanced using this method. Vortex simplifies the display and lowers the power required since only a portion of the screen needs to be active while retrieving text.

The personal communication device 1 of the present invention includes a central microprocessing means 2 that is capable of configuring and sending the voice or keyboard commands to an output means, generally indicated at 14, for transmission of commands to other devices. In the preferred embodiment the output means 14 consists of a Bluetooth or 802.11 radio transceiver chip 15 and antenna 16 and IRDA port 24. Suitable Bluetooth radio transceiver chips are available from Infineon, Toshiba and Cambridge Technologies. The present invention allows instant connection between all similarly equipped radio enabled devices. The personal communication device 1 of the present invention also allows voice connection (via Bluetooth to cell-phone link) to on-line voice gateways (ie TellMe, voiceXML and voice-email). The present invention includes various means of communications wired, wireless or otherwise. Further, it is applicable to the transmission of media types past, current and future. The preferred embodiment builds on the open architecture of the Bluetooth radio system and it's ability to set up and dissolve ad hoc communications networks. However the present invention may use any communications means and infrastructure.

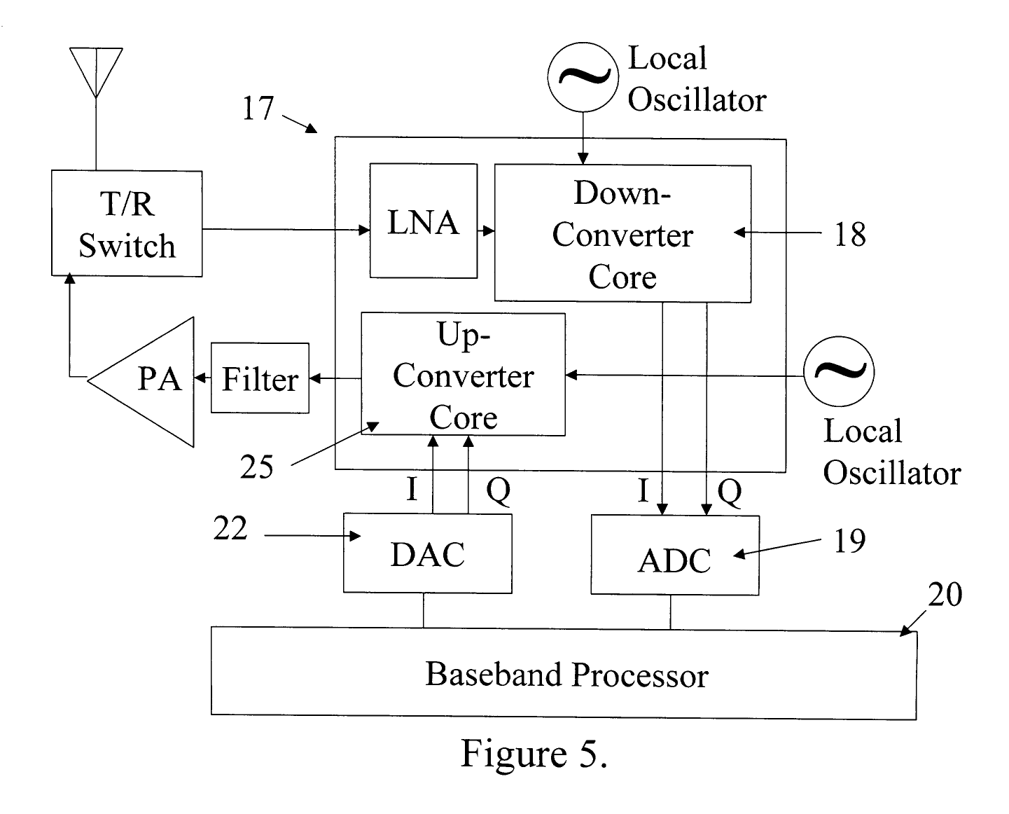

In order to obtain continuous and ubiquitous wireless connection to all types of electronic devices and allow the use of existing PC's and communications infrastructure the present invention includes as one of the microcircuits 2,3,4,5, one or more radio cards 17. The design optionally uses a software-configurable radio-frequency modem (FIG. 5) in order to communicate with existing and future radio frequency modems. In FIG. 5, a down-converter 18 provides a single frequency conversion to a baseband frequency. Note that the baseband in this instance may be a much higher frequency than a conventional superheterodyne converter. A very high speed analogue to digital converter (ADC) 19 then converts the baseband signal to a digital stream of bits. The baseband processor 20 then uses a DSP (Digital Signal Processing) routine to demodulate the received signal allowing data recovery. The DSP routine is specific to the radio protocol of interest. An up-converter chain operates in the reverse manner taking a digital stream of bits and converting it in to a baseband signal in baseband processor 20. The baseband signal is converted in a digital to analogue converter (DAC) 22 and converting it to an analogue signal. An up-converter 25 provides conversion of the analogue signal suitable for radio transmission. Today there are numerous radio modem protocols being promoted by chip manufacturers and service providers, some of which supply almost identical services (eg.GSM and CDMA, WiFi and HomeRF). This approach allows one radio chip (or chipset) to be used for several radio protocols thereby reducing the requirement for redundant multiple chipsets. All that is required is to load the proper DSP software for a given radio protocol. In addition, eliminating multiple conversion (mixing) stages and the associated filters reduces the cost of the radio. The unique application to this embodiment is that current and future radio protocols (modulation schemes) can readily accommodated. These would include 802.11a/g/e, HiperLAN and improvements to Bluetooth. This adds additional function (communications link) to any device or object. By radio it is understood to mean terrestrial short-distance communications such as Bluetooth, 802.11x, DECT, HomeRF, UWB (Ultra WideBand) and HiperLAN etc. The radio card(s) could be interfaced via PCI bus, PC-Card, Parallel, RS-232 Serial, USB, Infiniband, Secure Digital, Ethernet or optical interface. The present invention allows the use and convergence of existing and future radio equipped devices such as cellphones, PC's, laptops, PDA's, TV's, Stereo's, alarm panels, printers, digital cameras, fax machines, instant tellers, POS terminals, toys, intercom, GPS terminals and automobiles (telematics).

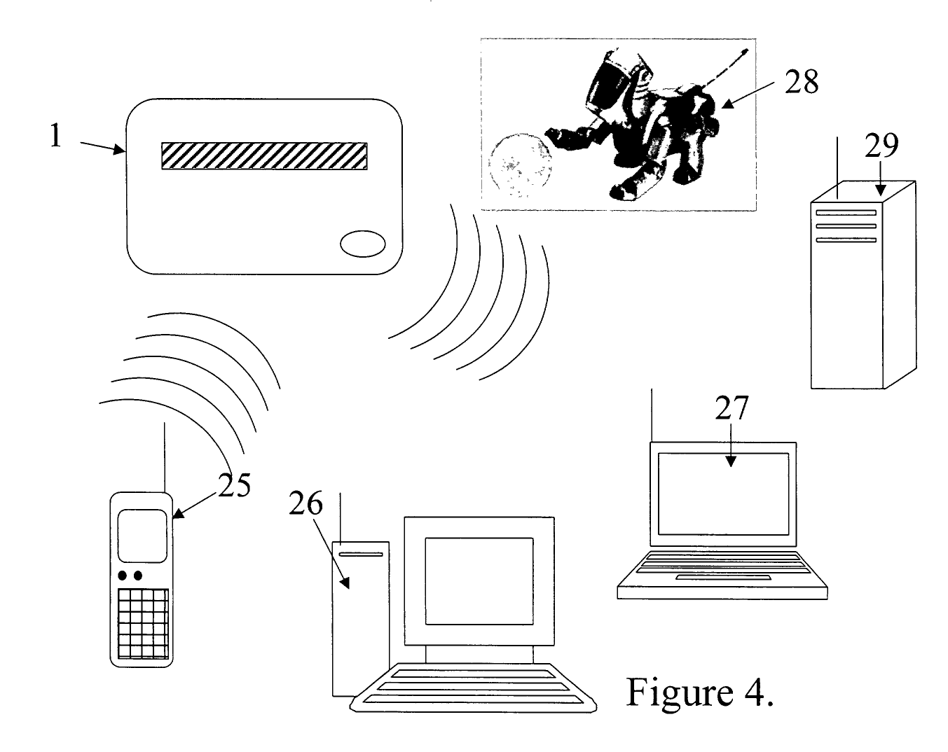

Other devices that can optionally be connected include a charged coupling (CCD) camera 32, Global Positioning Satellite interface (GPS) 33, indicator LEDs, and solar-array. The present invention allows instant communication to PC scheduler, phone directory, speakerphone (cellphone connection), cordless phone, automotive hands-free, automotive channel changer, voice-memo, email, intercom, clock, alarm, timer, lighting control, temperature control, emergency 911, patient monitor, personal (patient) tracking device, child tracking, Holter monitor, TV/Radio/Set-top box channel changer and volume controller (touch pad), security access control, camera, credit card, debit card, smart card, dictionary, calculator, accessory to visually impaired, payphone access, audible directions (map), talking book, advertising, locating lost articles (wallet, purse keys). FIG. 4 illustrates the wireless connection to some devices such as cell phone 25, PC 26, laptop 27, radio controlled toy 28 and network server 29.

In addition, the Bluetooth or like transceiver incorporated in chip also enables responses or messages or data from the devices being controlled by the personal communication device 1 to be received. These messages or data are communicated to the user either by sound through speaker 30, or by means of the OLED display 10.

Several novel concepts and new uses of existing technologies are preferably incorporated into the personal communication devices of the present invention to drastically improve life of battery 31 in this portable application. Battery lifetime in portable devices has long been a weak point in implementation. Since Bluetooth only requires a few milliwatts of transmit power the battery life would be much longer than cell-phone based devices that can require up to 2 Watt bursts. The personal communication devices are preferably adapted to be returned to depots to be re-cycled and recharged. Depots can be retail outlets and convenience stores (much like long-distance cards). The user merely initializes the re-cycled device and it becomes his voice portal. All previously stored information is retrieved from a host computer (PDA, laptop or desktop). Other previous owner cards are rendered inoperative for security reasons. Conventional PDA's rely on penlight or non-removable rechargeable batteries for power. This means having to keep spare batteries or employing a charging unit to power the PDA. This invention removes the reliance on replacement batteries and bulky charging units. Advanced battery technologies (ultracaps) and form-factors can be readily implemented since the user is not responsible for recharging or replacing batteries. Extended battery life can also be achieved by the use of solar cells on the front and back of the unit. Further, miniature fuel cells consisting of membrane, electrodes and catalyst, may be employed as a power source. Periodically, elements of the fuel cell (primarily the catalyst) must be renewed at a depot such as explained previously. This also exploits the novel approach of returning and recycling the entire communications device.

Additionally, the present invention may include the use of a SD (Secure Digital) Interface on a Smartcard. The SD Interface is a new electrical (electronic) interface based on a removable flashcard interface. The SD Interface specification has been extended to include miniature devices such as CCD cameras and radio modems. In this instance the SD Interface would be used primarily to connect miniature headphones (ear-buds). The device can be used as a remote camera, transmitting still or video information via the radio-modem link to a PC for storage or retransmission via electronic network. The camera could be used for security surveillance, advertising, entertainment etc.

### EXAMPLE

To exemplify the invention, a personal communication device can be assembled in accordance with the present invention using components selected from the following manufacturers:

| Component | Manufacturer | Part Number | Description |
|---|---|---|---|
| Bluetooth Radio | Infineon | PMB8760 | Blue-Moon |
| | Toshiba | TC35651 | Single |
| | Cambridge Tech. | BC212013A | Blue-Core 2 |
| Bluetooth PA | SiGe | SE2520 | |
| Radio Modem | SiRiFIC | | Software |
| | | | Configurable |
| RFID Radio | Transponder | Intellitag 2450 | |
| | Techologies | | |
| Voice Processor | Infineon | Uni-Speech | |
| Host Processor | ARM | ARM 7 | |
| | ARM | ARM9 | |
| | ARC | ARCtangent | |
| | | A4 | |
| | ARC | Blueform IP | Bluetooth IP core |
| | Zucotto | Xpresso 100 | |

| Component | Manufacturer | Part Number | Description |
|---|---|---|---|
| OLED Display | Kodak-Sanyo | Custom | |
| | Cambridge- | Custom | |
| | Osram | | |
| Touch Screen | 3M | Microtouch | |
| Microphone | Emkay | SP0101NZ1-2 | Silicon Microphone |
| Speaker | Emkay | EH Micro | |
| | | Speaker | |
| | JVC | DD Speaker | |
| Battery | Infinite Power | LiteSTAR | Thin Battery |
| | Solutions | | |
| | Polaroid | PolaPulse | Thin Battery |
| | Power Paper | Custom | TFM Energy Cell |
| Smartcard | IVI | Cryptocard | |
| IRDA Port | Vishay | IRM5000 | |

Having illustrated and described a preferred embodiment of the invention and certain possible modifications thereto, it should be apparent to those of ordinary skill in the art that the invention permits of further modification in arrangement and detail. All such modifications are covered by the scope of the invention.

The embodiments of the invention in which an exclusive property or privilege is claimed are defined as follows:

1. A personal communication device consisting of one or more microcircuits deposited onto a man portable substrate, said microcircuits including a voice recognition input means in order to input data, commands or messages by voice, means to configure said voice inputted data, command or message to be transmitted to another device, wireless transmitter means for transmitting said data, command or message to said other device, wireless receiver means for receiving data or messages from said other device and means to communicate data or messages received from said other device to the user.

2. A personal communication device according to claim 1 wherein said wireless transmitter means and wireless receiver means are embodied in a radio-frequency modem.

3. A personal communication device according to claim 2 wherein said radio frequency modem utilizes Bluetooth architecture.

4. A personal communication device to claim 3 wherein voice command pre-cursor software is incorporated into the voice recognition input means.

5. A personal communication device according to claim 4 wherein the said means to communicate data or messages received from said other device to the user includes a OLED display.

6. A personal communication device according to claim 5 wherein a virtual touchpad is provided over said OLED display.

7. A personal communication device according to claim 1-6 that is disposable or recyclable.

8. A personal communication device according to claim 7 wherein means are provided to extend battery life selected from the group consisting of low-power, short-distance radios (Bluetooth/802.11x) including ultra low-power RFID tag technology to monitor radio traffic., OLED display technology, ingenious uses of battery technologies and recyling rechargeable alkaline battery (Powerburst technology), rechargeable catalyst fuel-cell technology (methane), rechargeable Lithium-Ion, Lithium-Polymer or rechargeable Ultracap technology, Smartcard technology and credit-card form factor or Vortex™ display output
